(19) United States
(12) Patent Application Publication
(10) Pub. No.: US 2004/0121692 A1
(43) Pub. Date: Jun. 24, 2004

(54) Oil-resistant elastic laminates

(76) Inventors: Jack Draper Taylor, Roswell, GA (US); Stephen Carl Baumgartner, Neenah, WI (US); Monica Varriale, Woodstock, GA (US); Catherine Marguerite Hancock-Cooke, Neenah, WI (US)

Correspondence Address: PAULEY PETERSEN KINNE & ERICKSON, 2800 WEST HIGGINS ROAD, SUITE 365, HOFFMAN ESTATES, IL, 60195, US

(21) Appl. No.: 10/329,061

(22) Filed: Dec. 23, 2002

(51) Int. Cl. D04H 3/00; B32B 27/12

(52) U.S. Cl. 442/394; 442/400; 442/401; 442/328; 442/414

(57) ABSTRACT

An oil-resistant elastic laminate including an elastomeric sheet laminated to one or more nonwoven facing sheets with an oil-insensitive adhesive applied to a surface of the elastomeric sheet and/or the facing sheet(s), an oil-insensitive adhesive incorporated within the elastomeric sheet, and/or an oil-insensitive adhesive incorporated within the nonwoven facing sheet(s). The invention further includes methods of making oil-resistant elastic laminates.

### BACKGROUND OF THE INVENTION

This invention is directed to oil-resistant elastic laminates and methods of making oil-resistant elastic laminates. The oil-resistant elastic laminates are particularly suitable for use in disposable absorbent products.

A number of personal care products, or disposable absorbent products, include elastic components in such areas as waist bands, around leg openings, arm openings, and the like. It has been found that various oil-based products attack oil-sensitive elastomeric components and cause degradation of the components. For example, baby oil, creams, lotions, and the like, are often applied to a wearer's skin before a disposable absorbent garment, such as a diaper, is applied to the wearer. It has been discovered that such oils, creams, and lotions may detrimentally affect elastomeric components and elastomeric laminates.

Certain types of elastic are extremely oleophilic by nature. These types of elastic are often formulated with additional ingredients, such as adhesives, to improve melt processing and performance of the elastic material. When an oil-sensitive adhesive is included as part of the formulation of an elastic material, the resulting elastic material generally has very little oil resistance.

In particular, when such elastic materials are laminated to facings the resulting laminates have very little oil resistance. When these laminates are contacted by mineral oil, petrolatum, and the like, bonds between the elastic components and the facings tend to break such that the laminates quickly delaminate, and the elastomeric sheets quickly begin to disintegrate. This disintegration of the elastomeric sheets is caused by the oil swelling, softening, and partially dissolving the elastic polymer. The oil not only delaminates, but starts part of the delamination by attacking the elastomer and causing the elastomer to break; in those broken points is where some of the delamination starts. Oil-based products may also cause the elastomeric layer to relax and elongate even when the laminate has not yet been stretched. Furthermore, when the oil-contaminated elastomeric layer is stretched and relaxed it does not retract well, or more specifically, it has more permanent set.

There is a need or desire for an oil-resistant elastic laminate that can be used in disposable absorbent products and can withstand exposure to oil-based products without delaminating. There is a further need or desire for a method of making such oil-resistant elastic laminates.

### SUMMARY OF THE INVENTION

In response to the discussed difficulties and problems encountered in the prior art, oil-resistant elastic laminates, and method of making oil-resistant elastic laminates, have been discovered.

The invention uses oil-insensitive adhesive to bond or augment the bonding between elastomeric sheets and facing sheets. As used herein, the term “elastomeric sheet” may refer to either an elastomeric film or a layer of elastomeric strands. The resulting laminates have greatly improved resistance to degradation when exposed to oil-based products.

In one embodiment, the oil-resistant elastic laminates of the invention may include an elastomeric sheet treated with an oil-insensitive adhesive on one surface of the elastomeric sheet, with a nonwoven facing sheet laminated to the elastomeric sheet. Alternatively, the elastomeric sheet may be treated with an oil-insensitive adhesive on both surfaces, and laminated between two nonwoven facing sheets. Such a laminate may be formed by applying a hot-melt oil-insensitive adhesive to either the nonwoven facing sheet(s), the elastomeric sheet, or both; aligning the nonwoven facing sheet(s) and the elastomeric sheet with the hot-melt oil-insensitive adhesive between the layers; and passing the aligned nonwoven facing sheet(s) and elastomeric sheet through a pressure nip of a calender.

In another embodiment, the oil-resistant elastic laminates of the invention may include an oil-insensitive adhesive combined with an elastomeric polymer composition to create an oil-resistant elastomeric sheet. The oil-resistant elastomeric sheet may have one or more nonwoven facing sheets laminated to one or more surfaces of the elastomeric sheet.

In yet another embodiment, the oil-resistant laminates of the invention may include an oil-insensitive adhesive combined with a nonwoven web to create an oil-resistant nonwoven facing sheet. The oil-resistant nonwoven facing sheet is laminated to an elastomeric sheet. A second oil-resistant nonwoven facing sheet, or other nonwoven facing sheet, may also be laminated to the elastomeric sheet.

If the oil-insensitive adhesive is a powder at ambient temperatures but becomes a tacky adhesive at elevated temperatures, the powdered adhesive can be placed in the matrix of a fibrous facing material when forming the nonwoven facing. For example, if the facing is a spunbonded web the powdered adhesive could be blown into the spunbonded fiber matrix during the manufacture of the spunbonded web. The powdered adhesive-containing facing(s) and the elastomeric sheet could then be passed through the pressure nip of a heated calender. The heat would soften and activate the adhesive, and the pressure in the nip would accomplish bonding between the elastomeric sheet and the facing sheet(s). Similarly, the powdered adhesive could be located in the matrix of the elastomeric sheet. Alternatively, hot-melt oil-insensitive adhesives may be combined with the facings and/or the elastomeric sheet during formation of the facings and/or the elastomeric sheet. More specifically, the facings could be made with powder oil-insensitive adhesive blended within the facings and, once formed, sprayed with another adhesive.

The oil-resistant elastic laminates of the invention may be stretch-bonded laminates, necked-bonded laminates, continuous filament stretch-bonded laminates, vertical filament stretch-bonded laminates, stretch-film-laminates, or any other suitable type of laminate.

With the foregoing in mind, particular embodiments of the invention provide oil-resistant elastic laminates and methods of making oil-resistant elastic laminates.

### BRIEF DESCRIPTION OF THE DRAWINGS

FIG. 1 is a sectional view of one embodiment of an oil-resistant elastic laminate of the invention.

FIG. 2 is an illustration of one embodiment of an exemplary process for making an oil-resistant elastic laminate of the invention.

FIG. 3 is a sectional view of another embodiment of an oil-resistant elastic laminate of the invention.

FIG. 4 is an illustration of another embodiment of an exemplary process for making an oil-resistant elastic laminate of the invention.

FIG. 5 is a sectional view of yet another embodiment of an oil-resistant elastic laminate of the invention.

FIG. 6 is an illustration of yet another embodiment of an exemplary process for making an oil-resistant elastic laminate of the invention.

### DEFINITIONS

Within the context of this specification, each term or phrase below will include the following meaning or meanings.

“Bonded carded web” refers to webs made from staple length fibers that are carded into a web and then bonded by some technique such as thermal or adhesive bonding.

“Coform” refers to a material produced by combining separate polymer and additive streams (e.g. fluff pulp) into a single deposition stream in forming a nonwoven web. Such a process is taught, for example, by U.S. Pat. No. 4,100,324 to Anderson et al. which is hereby incorporated by reference.

“Elastomeric” is the property of a material that refers to its ability to extend when under a load and recover a significant portion of the load-induced extension after the load is removed. “Elastomeric” and “elastic” are used interchangeably to refer to a material or composite that is generally capable of recovering all or most of its shape after deformation when the deforming force is removed. Specifically, as used herein, elastic or elastomeric is meant to be that property of any material which, upon application of an elongating force, permits the material to be stretchable to a stretched length which is at least about 25 percent greater than its relaxed unstretched length, and that will cause the material to recover at least 40 percent of its elongation upon release of the stretching force. A hypothetical example which would satisfy this definition of an elastomeric material would be a ten (10) centimeter sample of a material which is elongatable to at least 12.5 centimeters and which, upon being elongated to 12.5 centimeters and released, will recover to a length of less than 11.5 centimeters. Many elastic materials may be stretched by much more than 25 percent of their relaxed length, and many of these will recover to substantially their original relaxed length upon release of the stretching force.

“Film” refers to a thermoplastic film made using a film extrusion and/or forming process, such as a cast film or blown film extrusion process. The term includes apertured films, slit films, and other porous films which constitute liquid transfer films, as well as films which do not transfer liquid.

“Laminated” and “laminating” refer to the bonding, joining, adhering, connecting, attaching, or the like, of two layers. Two layers will be considered to be laminated when they are laminated directly to one another or indirectly to one another, such as when each is directly laminated to intermediate elements.

“Machine direction” as applied to a film or web, refers to the direction on the film or web that was parallel to the direction of travel of the film or web as it left the extrusion or forming apparatus, or as it travels through a treatment process. If the film or web passed between nip rollers or chill rollers, for instance, the machine direction is the direction on the film or web that was parallel to the surface movement of the rollers when in contact with the film or web. “Cross direction” refers to the direction perpendicular to the machine direction.

“Meltblown fiber” means fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al. Meltblown fibers are microfibers which may be continuous or discontinuous, are generally smaller than about 0.6 denier, and are generally self bonding when deposited onto a collecting surface. Meltblown fibers used in the present invention are preferably substantially continuous in length.

“Neck” or “neck stretch” interchangeably mean that the fabric, nonwoven web or laminate is drawn such that it is extended under conditions reducing its width or its transverse dimension by stretching lengthwise or increasing the length of the fabric. The controlled drawing may take place under cool temperatures, room temperature or greater temperatures and is limited to an increase in overall dimension in the direction being drawn up to the elongation required to break the fabric, nonwoven web or laminate, which in most cases is about 1.2 to 1.6 times. When relaxed, the fabric, nonwoven web or laminate does not return totally to its original dimensions. The necking process typically involves unwinding a sheet from a supply roll and passing it through a brake nip roll assembly driven at a given linear speed. A take-up roll or nip, operating at a linear speed higher than the brake nip roll, draws the fabric and generates the tension needed to elongate and neck the fabric. U.S. Pat. No. 4,965,122 issued to Morman, and commonly assigned to the assignee of the present invention, discloses a reversibly necked nonwoven material which may be formed by necking the material, then heating the necked material, followed by cooling and is incorporated herein by reference in its entirety. The heating of the necked material causes additional crystallization of the polymer giving it a partial heat set. If the necked material is a spunbond web, some of the fibers in the web may become crimped during the necking process, as explained in U.S. Pat. No. 4,965,122.

“Necked-bonded laminate” refers to a material having an elastomeric film joined to a necked material at least at two places. The elastomeric film may be joined to the necked material at intermittent points or may be completely bonded thereto. The joining is accomplished while the elastic sheet and the necked material are in juxtaposed configuration. The composite elastic necked-bonded material is elastic in a direction generally parallel to the direction of neckdown of the necked material and may be stretched in that direction to the breaking point of the necked material. A necked-bonded laminate may include more than two layers. For example, the elastomeric film may have necked material joined to both of its sides so that a three-layer necked-bonded laminate is formed having a structure of necked material/elastomeric film/necked material. Additional elastomeric films and/or necked material layers may be added. Other combinations of elastomeric films and necked materials may also be used. For example, the elastomeric film may be in the form of strands or filaments instead of, or in addition to, a single sheet of film.

“Nonwoven” or “nonwoven web” refers to materials and webs of material having a structure of individual fibers or filaments which are interlaid, but not in an identifiable manner as in a knitted fabric. The terms “fiber” and “filament” are used interchangeably. Nonwoven fabrics or webs have been formed from many processes such as, for example, meltblowing processes, spunbonding processes, air laying processes, and bonded carded web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

“Oil-insensitive adhesive” refers to an adhesive that does not deteriorate, or otherwise react, in the presence of oil or oil-based products with which the adhesive would come in contact during contemplated use, such as baby oil, creams, lotions, and the like.

“Oil-resistant” refers to a material that can be contacted with oil or oil-based products and can withstand such contact without the properties of the material being destroyed or disabled.

“Polymers” include, but are not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries.

“Spunbond fiber” refers to small diameter fibers which are formed by extruding molten thermoplastic material as filaments from a plurality of fine capillaries of a spinnerette having a circular or other configuration, with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartmann, U.S. Pat. No. 3,502,538 to Petersen, and U.S. Pat. No. 3,542,615 to Dobo et al., each of which is incorporated herein in its entirety by reference. Spunbond fibers are quenched and generally not tacky when they are deposited onto a collecting surface. Spunbond fibers are generally continuous and often have average deniers larger than about 0.3, more particularly, between about 0.6 and 10.

“Strands” include filaments, fibers, ribbons, webs, and the like.

“Stretch-film-laminate” or “SFL” refers to a laminate in which a filled film layer is stretched prior to lamination to any facing sheets in order to enhance breathability of the film.

“Vertical filament stretch-bonded laminate” or “VF SBL” refers to a laminate made using a continuous vertical filament process. Suitable VF SBL materials include laminates as described, for example, in PCT International Application WO 01/88245, published on Nov. 22, 2001 in the name of Welch et al., which is incorporated herein by reference.

These terms may be defined with additional language in the remaining portions of the specification.

### DESCRIPTION OF PREFERRED EMBODIMENTS

The present invention is directed to oil-resistant elastic laminates and methods of making oil-resistant elastic laminates. To prevent or greatly reduce oil-induced delamination of elastic laminates, and to hold oil-savaged elastic components in place, oil-insensitive adhesives can be used in this invention to bond or augment the bonding between oil-sensitive elastic sheets and facing sheets. The resulting laminates have greatly improved resistance to degradation caused by oil attacking the extremely oil-sensitive elastic polymer in the elastic sheet.

In accordance with the invention, oil-insensitive adhesives can be used in several ways to improve the oil-resistance of elastic laminates. In one embodiment, illustrated in FIG. 1, an oil-resistant elastic laminate 20 of the invention includes an elastomeric sheet 22 treated with an oil-insensitive adhesive on one or both surfaces, with one or more nonwoven facing sheets 24 laminated to the elastomeric sheet. Alternatively, hot-melt oil-insensitive adhesives may be combined with the facings and/or the elastomeric sheet during formation of the facings and/or the elastomeric sheet. More specifically, the facings could be made with powder oil-insensitive adhesive blended within the facings. As used herein, the term “elastomeric sheet” may refer to either an elastomeric film or a layer of elastomeric strands.

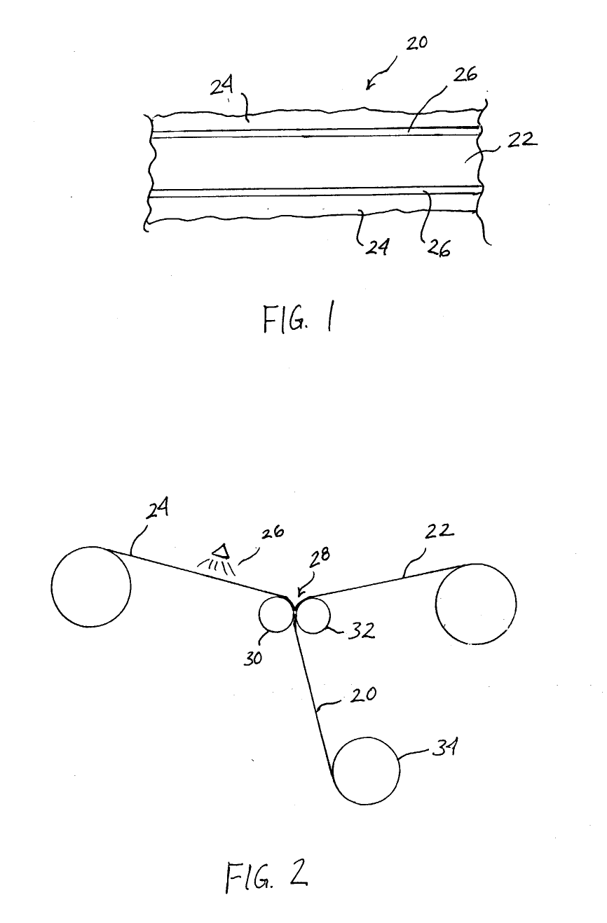

Referring to FIG. 2, there is shown an embodiment of a method of producing an oil-resistant elastic laminate 20. More specifically, as shown, an oil-insensitive adhesive 26 is applied to the nonwoven web 24. Alternatively, the adhesive could be applied to the elastomeric sheet 22, or to both the nonwoven web 24 and the elastomeric sheet 22. Once the adhesive is applied, the nonwoven web 24 and the elastomeric sheet 22 are aligned with the adhesive between the layers. The laminate 20 is then passed through a pressure nip 28 of a calender. Generally speaking, a nip is an area located between two rolls in close proximity. More specifically, the calender may include a calender roller 30 and an anvil roller 32 to bond the layers for further formation of the laminate 20. While the anvil roller 32 is suitably smooth, the calender roller 30 may be smooth or patterned to add a bond pattern to the web. Examples of suitable bond patterns include pin embossing or a sinusoidal bonding pattern. One or both of the calender roller 30 and the anvil roller 32 may be heated and the pressure between these two rollers may be adjusted by well-known means to provide the desired temperature, if any, and bonding pressure to form the laminate. The resulting laminate 20 can be wound up on a wind-up roll 34 for subsequent storage. Alternatively, a second nonwoven web can be applied to the elastomeric sheet 22, either simultaneously or consecutively, in the same manner that the nonwoven web 24 is applied to the elastomeric sheet.

The oil-insensitive adhesive 26 may be a polybutylene-based adhesive, or a syndiotactic polypropylene-based adhesive. An example of a commercially available syndiotactic polypropylene-based adhesive is available under the trade designation H9331, from Bostik Findley, Inc., of Middleton, Mass. The oil-insensitive adhesive may be either hot-melt or in powder form. If the oil-insensitive adhesive is a hot-melt type adhesive, it can be meltsprayed, meltblown, melt-coated, or the like, during the process. If the oil-insensitive adhesive is a powder at ambient temperatures but becomes a tacky adhesive at elevated temperatures, the powder can be applied between layers of the laminate, or blended within one or more layers of the laminate, and the laminate can then be passed through the pressure nip of a heated calender to allow the heat to soften and activate the adhesive while the pressure in the nip accomplishes bonding between the layers.

The elastomeric sheet 22 may be in the form of an elastomeric film or multiple elastomeric strands, such as filaments, fibers, ribbons, webs, and the like. Suitably, the elastomeric sheet may have a thickness between about 1.2 to about 3 mils, and/or strand density of about 3 to about 18 strands per inch, for example. The elastomeric sheet can be made from any suitable elastomeric film-forming resins or blends containing the same. For example, materials suitable for use in preparing the elastomeric sheet include diblock, triblock, tetrablock, or other multi-block elastomeric copolymers such as olefinic copolymers, including styrene-isoprene-styrene, styrene-butadiene-styrene, styrene-ethylene/butylene-styrene, or styrene-ethylene/propylene-styrene, which may be obtained from Kraton Polymers, under the trade designation KRATON elastomeric resin; polyurethanes, including those available from E. I. Du Pont de Nemours Co., under the trade name LYCRA polyurethane; polyamides, including polyether block amides available from Ato Chemical Company, under the trade name PEBAX polyether block amide; polyesters, such as those available from E. I. Du Pont de Nemours Co., under the trade name HYTREL polyester; and single-site or metallocene-catalyzed polyolefins having density less than about 0.89 grams/cubic centimeter, available from Dow Chemical Co. under the trade name AFFINITY.

A number of block copolymers can also be used to prepare the elastomeric sheet used in this invention. Such block copolymers generally include an elastomeric midblock portion B and a thermoplastic endblock portion A. The block copolymers may also be thermoplastic in the sense that they can be melted, formed, and resolidified several times with little or no change in physical properties (assuming a minimum of oxidative degradation). Alternatively, the elastomeric sheet can be made of a polymer that is not thermally processable, such as LYCRA® spandex, available from E. I. Du Pont de Nemours Co., or cross-linked natural rubber in film or fiber form. Thermoset polymers and polymers such as spandex, unlike the thermoplastic polymers, once cross-linked cannot be thermally processed, but can be obtained on a spool or other form and can be stretched and applied as strands in the same manner as thermoplastic polymers. As another alternative, the elastomeric sheet can be made of a polyolefin plastomer, such as AFFINITY, available from Dow Chemical Co., that can be processed like a thermoplastic, i.e. stretched and applied, and then treated with radiation, such as electron beam radiation, gamma radiation, or UV radiation to cross-link the polymer, or use polymers that have functionality built into them such that they can be moisture-cured to cross-link the polymer, thus resulting in a polymer and the enhanced mechanical properties of a thermoset.

Endblock portion A may include a poly(vinylarene), such as polystyrene. Midblock portion B may include a substantially amorphous polyolefin such as polyisoprene, ethylene/propylene polymers, ethylene/butylene polymers, polybutadiene, and the like, or mixtures thereof.

Suitable block copolymers useful in this invention include at least two substantially polystyrene endblock portions and at least one substantially ethylene/butylene mid-block portion. A commercially available example of such a linear block copolymer is available from Kraton Polymers under the trade designation KRATON G1657 elastomeric resin. Another suitable elastomer is KRATON G2760.

The elastomeric sheet may also be a multilayer material in that it may include two or more individual coherent webs or films. Additionally, the elastomeric sheet may be a multilayer material in which one or more of the layers contain a mixture of elastic and non-elastic fibers or particulates.

The nonwoven layer or layers 24 are made up of filaments randomly deposited and formed into a nonwoven web, in a manner conventionally used to form nonwoven webs as known to those skilled in the art. The nonwoven web may be made of filament-forming polymers such as, for example, polyolefins. Exemplary polyolefins include one or more of polypropylene, polyethylene, ethylene copolymers, propylene copolymers, and butene copolymers. The filaments may be meltblown fibers, spunbond fibers, bi-component fibers, sheath-core fibers, side-by-side fibers, or any other suitable type of filaments. The nonwoven web may be a spunbond web, a meltblown web, a bonded carded web, coform, or any other suitable type of nonwoven facing. For example, the nonwoven web may be polypropylene spunbond having a basis weight between about 0.3 and about 0.85 osy.

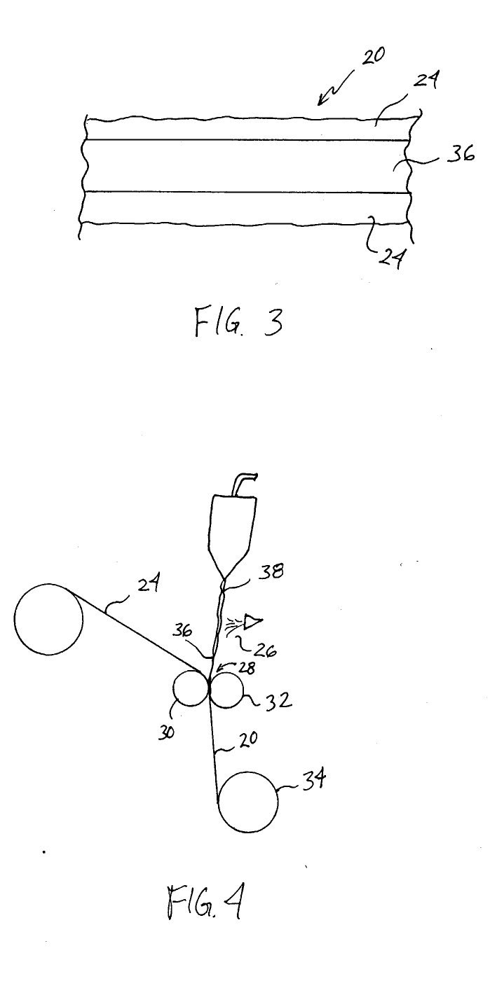

In another embodiment, illustrated in FIG. 3, an oil-resistant elastic laminate 20 of the invention includes an oil-resistant elastomeric sheet 36 including an oil-insensitive adhesive compounded with a polymer composition, and one or more nonwoven facing sheets 24 laminated to the oil-resistant elastomeric sheet 36.

Referring to FIG. 4, there is shown another embodiment of a method of producing an oil-resistant elastic laminate 20. More specifically, as shown, an oil-insensitive adhesive 26 is combined with an elastomeric polymer composition 38 to form an oil-resistant elastomeric sheet 36. The oil-resistant elastomeric sheet 36 is aligned with a nonwoven web 24 and the aligned layers are then passed through a pressure nip 28 of a calender, including a calender roller 30 and an anvil roller 32. The resulting laminate 20 can be wound up on a wind-up roll 34 for subsequent storage. Alternatively, a second nonwoven web can be applied to the oil-resistant elastomeric sheet 36, either simultaneously or consecutively, in the same manner that the nonwoven web 24 is applied to the oil-resistant elastomeric sheet. As mentioned, the oil-insensitive adhesive 26 may be of a hot-melt type or in a powder form. When using a powder form, the powder adhesive can be added to a matrix formed from the elastomeric polymer composition by blowing the powder into a matrix of the elastomeric sheet, for example. Thus, when the aligned layers are passed through the pressure nip 28 of the calender, namely a heated calender, the heat softens and activates the adhesive while the pressure in the nip accomplishes bonding between the elastomeric sheet and the nonwoven facing or facings.

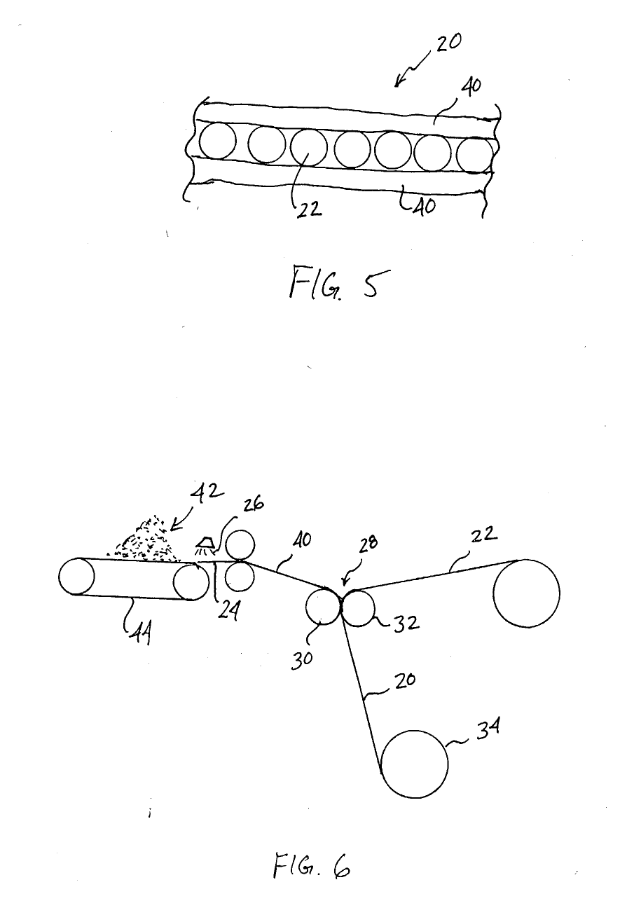

In another embodiment, illustrated in FIG. 5, an oil-resistant elastic laminate 20 of the invention includes an elastomeric sheet 22 laminated to one or more oil-resistant nonwoven facing sheets 40. The oil-resistant nonwoven facing sheets 40 include an oil-insensitive adhesive combined with a nonwoven web.

Referring to FIG. 6, there is shown another embodiment of a method of producing an oil-resistant elastic laminate 20. More specifically, as shown, filaments 42 are randomly deposited onto a forming belt 44 to form a nonwoven web 24, in a manner conventionally used to form nonwoven webs as known to those skilled in the art. As the filaments 42 are deposited on the forming belt 44, a vacuum unit may be positioned under the forming belt to draw the filaments towards the forming belt during the formation of the nonwoven web. The filaments 42 can be joined by interfiber bonding to form a coherent web structure which is able to withstand stretching or necking. Interfiber bonding may be produced by entanglement between individual meltblown fibers. The fiber entangling is inherent in the meltblown process but may be generated or increased by processes such as, for example, hydraulic entangling or needlepunching. Additionally, a bonding agent, in this case an oil-insensitive adhesive 26, is added to the nonwoven web 24 during formation to increase the desired bonding as well as to create the oil-resistant nonwoven web 40.

The oil-resistant nonwoven web 40 is aligned with an elastomeric sheet 22 and the aligned layers are then passed through a pressure nip 28 of a calender, including a calender roller 30 and an anvil roller 32. The resulting laminate 20 can be wound up on a wind-up roll 34 for subsequent storage. Alternatively, a second nonwoven web, either an oil-resistant nonwoven web 40 or a conventional nonwoven web 24, can be applied to the elastomeric sheet 22, either simultaneously or consecutively, in the same manner that the oil-resistant nonwoven web 40 is applied to the elastomeric sheet 22. As mentioned, the oil-insensitive adhesive may be of a hot-melt type or in a powder form. When using a powder form, the powder adhesive can be added to a matrix formed by the nonwoven web by blowing the powder into a matrix of the nonwoven web, for example. Thus, when the aligned layers are passed through the pressure nip 28 of the calender, namely a heated calender, the heat softens and activates the adhesive while the pressure in the nip accomplishes bonding between the elastomeric sheet and the nonwoven facing or facings.

The oil-resistant elastic laminates 20 of the invention may be stretch-bonded laminates, in which the elastomeric sheet is stretched while bonding the elastomeric sheet to the nonwoven facing or facings, and may be carried out in a continuous filament stretch-bond laminating process or a vertical filament laminating process. The resulting stretch-bonded laminate attains stretchability, as well as retraction, in a machine direction. Continuous filament stretch-bonded laminates are taught, for example, in U.S. Pat. No. 5,385,775 issued Jan. 31, 1995, to Wright. A vertical filament laminating process is taught, for example, in U.S. Patent Publication No. 20020104608, filed Aug. 8, 2002, by Welch, et al. Alternatively, oil-resistant elastic laminates 20 of the invention may be stretch-film laminates, in which the elastomeric sheet is stretched prior to bonding the elastomeric sheet to the nonwoven facing or facings. As another alternative, the nonwoven facing sheet or sheets may be necked prior to being laminated to the elastomeric sheet to create a laminate having stretchability, as well as retraction, in a cross direction. As yet another alternative, the nonwoven facing sheet or sheets may be necked and the elastomeric sheet may be stretched during the lamination process to create a laminate having biaxial stretch and retraction.

In each of the embodiments of this invention, the addition level of the oil-insensitive adhesive to the nonwoven facings and/or elastomeric sheet, whether applied to a surface or incorporated into the layer, is suitably between about 0.5 and about 10 grams per square meter (gsm), or between about 4 and about 10 gsm, or between about 0.5 and about 5 gsm, depending in large part on whether the elastomeric sheet is a film or filaments or the like. The facing materials should also be taken into consideration when determining add-on levels. For example, higher add-on levels may cause bleed-through in porous facings such as spunbond, but for other facing types add-on levels even greater than 10 gsm may be suitable.

The oil-resistant elastic laminates of the invention are particularly suitable for use in disposable absorbent products including, without limitation, diapers, training pants, swimwear, absorbent underpants, adult incontinence products, feminine hygiene products, absorbent wipes, bandages, and the like, as well as protective garments, including medical garments and industrial protective garments. Medical garments include surgical garments, gowns, aprons, face masks, absorbent drapes, and the like. Industrial protective garments include protective uniforms, workwear, and the like.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. An oil-resistant elastic laminate, comprising:
an elastomeric sheet treated with an oil-insensitive adhesive on at least one surface of the elastomeric sheet; and
at least one nonwoven facing sheet laminated to the at least one surface of the elastomeric sheet.

2. The oil-resistant elastic laminate of claim 1, wherein the elastomeric sheet comprises a plurality of elastomeric strands.

3. The oil-resistant elastic laminate of claim 1, wherein the elastomeric sheet comprises an elastomeric film.

4. The oil-resistant elastic laminate of claim 1, wherein the at least one nonwoven facing comprises at least one of a group consisting of spunbond, meltblown, bonded carded web, coform, and combinations thereof.

5. The oil-resistant elastic laminate of claim 1, wherein the elastomeric sheet is treated with the oil-insensitive adhesive on two surfaces of the elastomeric sheet and two nonwoven facing sheets are each laminated to one of the surfaces of the elastomeric sheet.

6. The oil-resistant elastic laminate of claim 1, wherein the oil-insensitive adhesive comprises a hot-melt type adhesive.

7. The oil-resistant elastic laminate of claim 1, wherein the oil-insensitive adhesive comprises a powder at ambient temperatures.

8. The oil-resistant elastic laminate of claim 1, wherein the oil-insensitive adhesive comprises a syndiotactic polypropylene-based composition.

9. An oil-resistant elastic laminate, comprising:
an oil-resistant elastomeric sheet including an oil-insensitive adhesive compounded with a polymer composition; and
at least one nonwoven facing sheet laminated a surface of the oil-resistant elastomeric sheet.

10. The oil-resistant elastic laminate of claim 9, wherein the elastomeric sheet comprises a plurality of elastomeric strands.

11. The oil-resistant elastic laminate of claim 9, wherein the elastomeric sheet comprises an elastomeric film.

12. The oil-resistant elastic laminate of claim 9, wherein the at least one nonwoven facing comprises at least one of a group consisting of spunbond, meltblown, bonded carded web, coform, and combinations thereof.

13. The oil-resistant elastic laminate of claim 9, comprising two nonwoven facing sheets each laminated to a surface of the oil-resistant elastomeric sheet.

14. The oil-resistant elastic laminate of claim 9, wherein the oil-insensitive adhesive comprises a hot-melt type adhesive compounded with the polymer composition.

15. The oil-resistant elastic laminate of claim 9, wherein the oil-insensitive adhesive comprises a powder at ambient temperatures, with the powder located in a matrix of the elastomeric sheet.

16. The oil-resistant elastic laminate of claim 9, wherein the oil-insensitive adhesive comprises a syndiotactic polypropylene-based composition.

17. An oil-resistant elastic laminate, comprising:
at least one oil-resistant nonwoven facing sheet including an oil-insensitive adhesive combined with a nonwoven web; and
an elastomeric sheet laminated to a surface of each of the at least one oil-resistant nonwoven facing sheet.

18. The oil-resistant elastic laminate of claim 17, wherein the elastomeric sheet comprises a plurality of elastomeric strands.

19. The oil-resistant elastic laminate of claim 17, wherein the elastomeric sheet comprises an elastomeric film.

20. The oil-resistant elastic laminate of claim 17, wherein the at least one oil-resistant nonwoven facing sheet comprises at least one of a group consisting of spunbond, meltblown, bonded carded web, coform, and combinations thereof.

21. The oil-resistant elastic laminate of claim 17, comprising two oil-resistant nonwoven facing sheets each laminated to a surface of the elastomeric sheet.

22. The oil-resistant elastic laminate of claim 17, wherein the oil-insensitive adhesive comprises a hot-melt type adhesive.

23. The oil-resistant elastic laminate of claim 17, wherein the oil-insensitive adhesive comprises a powder at ambient temperatures, with the powder located in a matrix of the at least one oil-resistant nonwoven facing sheet.

24. The oil-resistant elastic laminate of claim 17, wherein the oil-insensitive adhesive comprises a syndiotactic polypropylene-based composition.

25. A method of making an oil-resistant elastic laminate, comprising:
applying an oil-insensitive adhesive to at least one of a nonwoven facing sheet and an elastomeric sheet;
aligning the nonwoven facing sheet and the elastomeric sheet with the oil-insensitive adhesive therebetween; and
passing the aligned nonwoven facing sheet and elastomeric sheet through a pressure nip of a calender.

26. The method of claim 25, comprising stretching the elastomeric sheet while bonding the elastomeric sheet to the nonwoven facing sheet.

27. The method of claim 25, further comprising necking the nonwoven facing sheet.

28. The method of claim 25, comprising laminating the elastomeric sheet and the nonwoven facing sheet in a continuous filament stretch-bond laminating process.

29. The method of claim 25, comprising laminating the elastomeric sheet and the nonwoven facing sheet in a vertical filament stretch-bond laminating process.

30. The method of claim 25, comprising meltspraying the oil-insensitive adhesive onto at least one of the nonwoven facing sheet and the elastomeric sheet.

31. The method of claim 25, comprising meltblowing the oil-insensitive adhesive onto at least one of the nonwoven facing sheet and the elastomeric sheet.

32. The method of claim 25, comprising melt-coating the oil-insensitive adhesive onto at least one of the nonwoven facing sheet and the elastomeric sheet.

33. The method of claim 25, further comprising aligning a second nonwoven facing sheet and the elastomeric sheet with at least some of the oil-insensitive adhesive therebetween.

34. The method of claim 25, further comprising winding the oil-resistant elastic laminate onto a roll.

35. The method of claim 25, wherein the elastomeric sheet comprises a plurality of elastomeric strands.

36. The method of claim 25, wherein the elastomeric sheet comprises an elastomeric film.

37. The method of claim 25, wherein the at least one nonwoven facing comprises at least one of a group consisting of spunbond, meltblown, bonded carded web, coform, and combinations thereof.

38. A method of making an oil-resistant elastic laminate, comprising:
combining an oil-insensitive adhesive with an elastomeric polymer composition;
forming an oil-resistant elastomeric sheet from the combined oil-insensitive adhesive and elastomeric polymer composition; and
calender bonding the oil-resistant elastomeric sheet to at least one nonwoven facing sheet.

39. The method of claim 38, comprising stretching the elastomeric sheet while bonding the elastomeric sheet to the nonwoven facing sheet.

40. The method of claim 38, further comprising necking the at least one nonwoven facing sheet.

41. The method of claim 38, comprising laminating the elastomeric sheet and the at least one nonwoven facing sheet in a continuous filament stretch-bond laminating process.

42. The method of claim 38, comprising laminating the elastomeric sheet and the at least one nonwoven facing sheet in a vertical filament stretch-bond laminating process.

43. The method of claim 38, further comprising winding the oil-resistant elastic laminate onto a roll.

44. The method of claim 38, wherein the elastomeric sheet comprises a plurality of elastomeric strands.

45. The method of claim 38, wherein the elastomeric sheet comprises an elastomeric film.

46. The method of claim 38, wherein the at least one nonwoven facing comprises at least one of a group consisting of spunbond, meltblown, bonded carded web, coform, and combinations thereof.

47. The method of claim 38, wherein the oil-insensitive adhesive comprises a hot-melt type adhesive, and compounding the oil-insensitive adhesive with the polymer composition.

48. The method of claim 38, wherein the oil-insensitive adhesive comprises a powder at ambient temperatures, and adding the powder adhesive to a matrix formed from the elastomeric polymer composition.

49. A method of making an oil-resistant elastic laminate, comprising:
forming at least one nonwoven web;
adding an oil-insensitive adhesive to the at least one nonwoven web during formation of the nonwoven web;
aligning the at least one nonwoven web with an elastomeric sheet; and
passing the at least one aligned nonwoven web and elastomeric sheet through a pressure nip of a heated calender.

50. The method of claim 49, comprising stretching the elastomeric sheet while bonding the elastomeric sheet to the at least one nonwoven web.

51. The method of claim 49, further comprising necking the at least one nonwoven web.

52. The method of claim 49, comprising laminating the elastomeric sheet and the at least one nonwoven web in a continuous filament stretch-bond laminating process.

53. The method of claim 49, comprising laminating the elastomeric sheet and the at least one nonwoven web in a vertical filament stretch-bond laminating process.

54. The method of claim 49, further comprising winding the oil-resistant elastic laminate onto a roll.

55. The method of claim 49, wherein the elastomeric sheet comprises a plurality of elastomeric strands.

56. The method of claim 49, wherein the elastomeric sheet comprises an elastomeric film.

57. The method of claim 49, wherein the at least one nonwoven facing comprises at least one of a group consisting of spunbond, meltblown, bonded carded web, coform, and combinations thereof.

58. The method of claim 49, wherein the oil-insensitive adhesive comprises a hot-melt type adhesive.

59. The method of claim 49, wherein the oil-insensitive adhesive comprises a powder at ambient temperatures, and adding the powder adhesive to a matrix of the at least one nonwoven web.
